(19) United States
(12) Patent Application Publication
(10) Pub. No.: US 2026/0369092 A1
(43) Pub. Date: Nov. 19, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Nobuhiro UEDA, Tokyo (JP); Yuyang DONG, Tokyo (JP); Masafumi OYAMADA, Tokyo (JP)

(73) Assignee: NEC Corporation, Tokyo (JP)

(21) Appl. No.: 19/656,129

(22) Filed: Apr. 23, 2026

(30) Foreign Application Priority Data
May 15, 2025 (JP) 2025-082033

(51) Int. Cl. G06V 30/414; G06T 7/11

(52) U.S. Cl. CPC G06V 30/414; G06T 7/11; G06V 2201/07

(57) ABSTRACT

In an information processing device, a partial region acquisition means acquires a plurality of partial regions from content. A selection means selects a region set from the plurality of partial regions. A conversion means converts each of the partial regions included in the region set into optional content.

### INCORPORATION BY REFERENCE

This application is based upon and claims the benefit of priority from Japanese patent application No. 2025-082033, filed on May 15, 2025, the disclosure of which is incorporated herein in its entirety by reference.

### TECHNICAL FIELD

The present disclosure relates to a technique for converting a document including a visual element into text.

### BACKGROUND ART

A technique for converting a document image into text is known. For example, Patent Document 1 discloses a character string recognition device that recognizes a character string included in an image.
Patent Document 1: JP 7382544 B2

### SUMMARY

However, in the approach of Patent Document 1, conversion into text of a table structure or a figure structure included in a document image is not considered.

One object of the present disclosure is to provide an information processing device capable of converting a document including a visual element into text.

According to an example aspect of the present invention, there is provided an information processing device, including:
at least one memory configured to store instructions; and
at least one processor configured to execute the instructions to:
acquire a plurality of partial regions from content;
select a region set from the plurality of partial regions; and
convert each of the partial regions included in the region set into optional content.

According to another example aspect of the present invention, there is provided an information processing method including:
acquiring a plurality of partial regions from content;
selecting a region set from the plurality of partial regions; and
converting each of the partial regions included in the region set into optional content.

According to a further example aspect of the present invention, there is provided a recording medium recording a program for causing a computer to execute processing including:
acquiring a plurality of partial regions from content;
selecting a region set from the plurality of partial regions; and
converting each of the partial regions included in the region set into optional content.

According to the present disclosure, a document including a visual element can be converted into text.

### BRIEF DESCRIPTION OF THE DRAWINGS

FIG. 1 illustrates an information processing device according to the present disclosure;

FIG. 2 is a block diagram illustrating a hardware configuration of the information processing device according to the present disclosure;

FIG. 3 is a block diagram illustrating a functional configuration of the information processing device according to the present disclosure;

FIG. 4 illustrates an example of region segmentation performed by a region segmentation unit;

FIGS. 5A and 5B are diagrams for explaining an outline of a process performed by a rectangle selection unit;

FIGS. 6A to 6C are diagrams for explaining the process performed by the rectangle selection unit;

FIGS. 7A and 7B illustrate an example of region segmentation performed again by the region segmentation unit;

FIG. 8 is a flowchart of a process performed by the information processing device according to the present disclosure;

FIG. 9 is a block diagram illustrating a functional configuration of another information processing device according to the present disclosure; and

FIG. 10 is a flowchart of a process performed by the another information processing device according to the present disclosure.

### EXAMPLE EMBODIMENT

Hereinafter, preferred example embodiments of the present disclosure will be described with reference to the drawings.

### First Example Embodiment

### Description of Outline

A mechanism called retrieval augmented generation (RAG) that utilizes external knowledge to supplement internal knowledge that a large language model (LLM) has is known. The external knowledge of the RAG is mainly created based on a text such as a sentence or an article.

As the external knowledge in the RAG, it is desirable that not only a sentence or an article but also a document including a visual element such as a figure or a table, for example, can be utilized as the external knowledge. As an approach for converting a document image including a visual element into text, there is an approach of using a vision language model (VLM). The VLM can describe a figure structure or a table structure on a text basis. However, the VLM may not be able to sufficiently recognize a complicated document or a thorough document, and omission of conversion into text may occur in some cases. As described above, it is sometimes infeasible to perform text conversion with sufficient accuracy simply by inputting a document image including a visual element into the VLM. Therefore, in the present example embodiment, first, a document image including a visual element is segmented into regions, and then text conversion by the VLM is executed on each segmented region. As a result, since the amount of information handled by the VLM at a time is reduced, the completeness and preciseness of the text conversion can be enhanced.

### Schematic Configuration

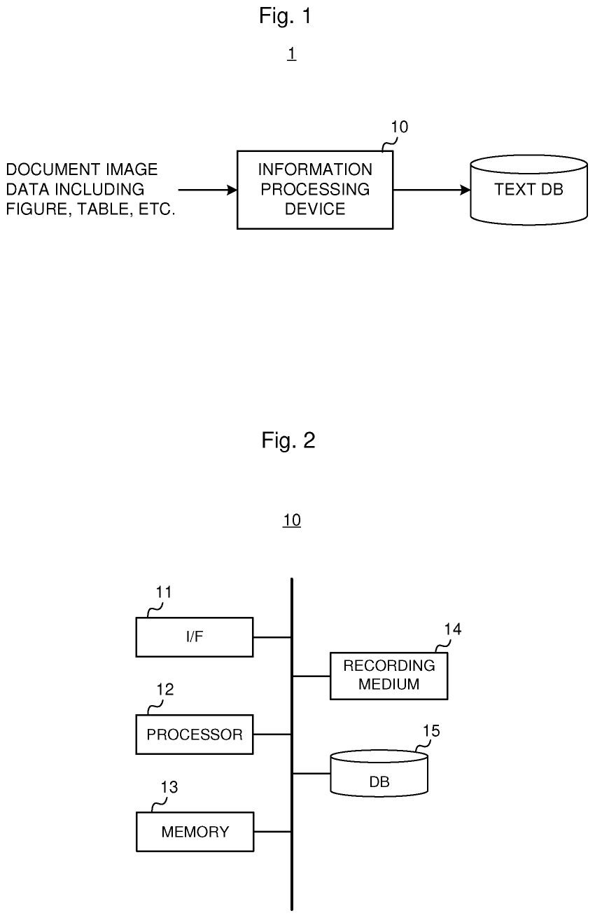

FIG. 1 illustrates an information processing device according to the present disclosure. Document image data including a figure, a table, and the like is input into an information processing device 10. The information processing device 10 converts the document image data into text and outputs the converted text to a text database (DB). The text DB is used as, for example, external knowledge of the RAG.

Here, the VLM is a model capable of integrally processing visual information (images and videos) and text (language data). The VLM accepts an input of visual information and text and outputs a response to the input with an image, a video, or a text. Examples of the VLM include Bootstrapping Language-Image Pre-training 2 (BLIP-2), Flamingo, Large Language and Vision Assistant (LLaVA), and Qwen-VL.

### Hardware Configuration

FIG. 2 is a block diagram illustrating a hardware configuration of the information processing device 10 according to the first example embodiment. As illustrated, the information processing device 10 includes an interface (I/F) 11, a processor 12, a memory 13, a recording medium 14, and a database (DB) 15.

The I/F 11 communicates with a terminal device 5 and an external LLM through a network such as the Internet.

The processor 12 is a computer such as a central processing unit (CPU) and takes overall control of the information processing device 10 by executing a program prepared in advance. The processor 12 may be a graphics processing unit (GPU), a digital signal processor (DSP), a micro processing unit (MPU), a floating point unit (FPU), a physics processing unit (PPU), a tensor processing unit (TPU), a quantum processor, a microcontroller, or a combination thereof. The processor 12 executes a text conversion process to be described later.

The memory 13 includes a read only memory (ROM), a random access memory (RAM), and the like. The memory 13 is also used as a working memory during execution of various processes by the processor 12.

The recording medium 14 is a non-volatile non-transitory recording medium such as a disk-shaped recording medium or a semiconductor memory and is detachably attachable to the information processing device 10. The recording medium 14 records various programs to be executed by the processor 12. When the information processing device 10 executes various processes, a program recorded in the recording medium 14 is loaded into the memory 13 and is executed by the processor 12. The DB 15 stores, for example, a prompt, a result of the text conversion process, and the like.

In addition to the above, the information processing device 10 may include a display device such as a liquid crystal display and an input device such as a keyboard or a mouse. The display device and the input device are used by an administrator of the information processing device 10 to perform necessary management, for example.

### Functional Configuration

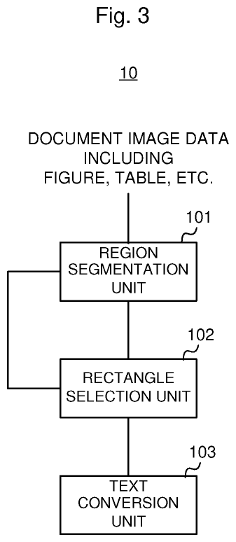

FIG. 3 is a block diagram illustrating a functional configuration of the information processing device 10 according to the first example embodiment. The information processing device 10 functionally includes a region segmentation unit 101, a rectangle selection unit 102, and a text conversion unit 103.

The region segmentation unit 101, the rectangle selection unit 102, and the text conversion unit 103 are constituted by the processor 12 illustrated in FIG. 2.

The region segmentation unit 101 acquires document image data including a figure, a table, and the like through the I/F 11. The region segmentation unit 101 performs region segmentation on the document image data. Here, the region segmentation unit 101 performs region segmentation focusing on semantic group instead of document elements (such as a figure, a table, and a text). The semantic group indicates a group of semantically deeply related elements among a plurality of elements included in the document image data. That is, in a case where a certain element is essential to understand the meaning of another element, these elements are regarded as a semantic group. The semantic group is made up of, for example, a paragraph title and a paragraph, a figure and a caption, and the like.

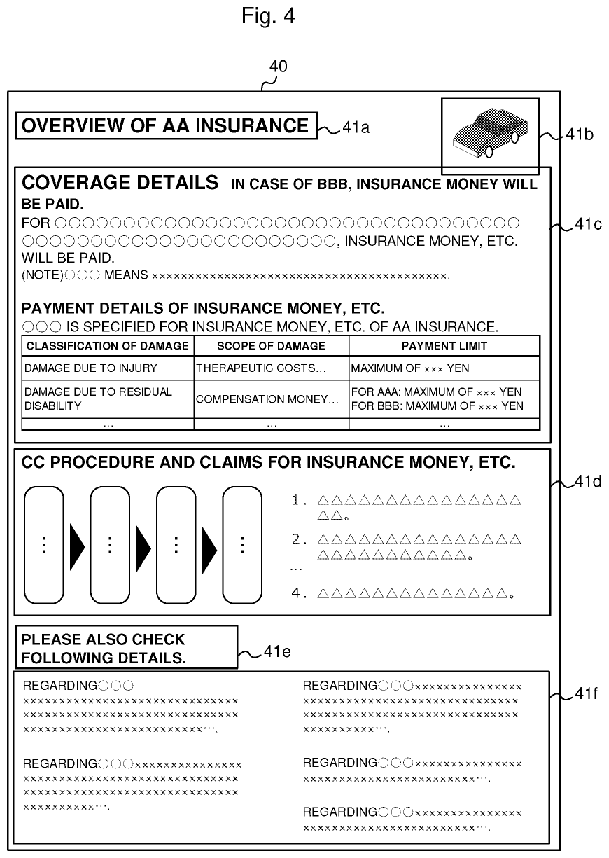

FIG. 4 illustrates an example of region segmentation performed by the region segmentation unit 101. In FIG. 4, the region segmentation unit 101 segments document image data 40 into rectangular regions 41a to 41f forming semantic groups. For example, in the rectangular region 41d, the paragraph title, the figure, and the caption are recognized as one semantic group.

The region segmentation unit 101 can perform the region segmentation as described above by using a trained object detection model. As the object detection model, for example, a You Only Look Once (YOLO) series model, an End-to-End Object Detection with Transformers (DETR) model, a Real-Time Detection Transformer (RT-DETR) model, or the like is used. As a training data set, for example, a data set in which a region forming a semantic group in document image data is annotated with a rectangle, or the like is used.

The region segmentation unit 101 outputs the document image data subjected to region segmentation, to the rectangle selection unit 102. Each region of the document image data segmented by the region segmentation unit 101 will be hereinafter also referred to as a “candidate rectangle”.

The rectangle selection unit 102 selects a candidate rectangle to be used for a subsequent process, from among the candidate rectangles included in the document image data.

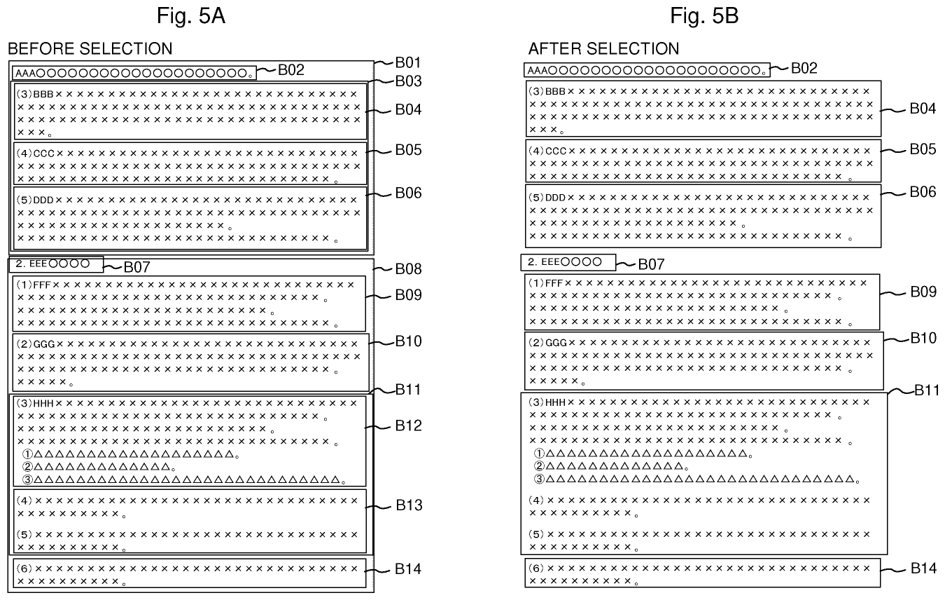

FIGS. 5A and 5B are diagrams for explaining an outline of a process performed by the rectangle selection unit 102. In FIGS. 5A and 5B, for convenience of description, document image data including only characters is used. FIG. 5A illustrates a result of region segmentation performed by the region segmentation unit 101. The region segmentation unit 101 segments certain document image data into candidate rectangles B01 to B14. As illustrated in FIG. 5A, in the region segmentation performed by the region segmentation unit 101, candidate rectangles having overlapping regions may sometimes be output. FIG. 5B illustrates a result of selecting candidate rectangles by the rectangle selection unit 102. The rectangle selection unit 102 selects a rectangle set of candidate rectangles B02, B04 to B07, B09 to B11, and B14 from the candidate rectangles B01 to B14. As illustrated in FIG. 5B, the rectangle selection unit 102 selects a rectangle set in such a way that there is no overlap and no missing or omission, that is, in such a way as to be mutually exclusive collectively exhaustive (MECE).

The candidate rectangle selected by the rectangle selection unit 102 will be hereinafter also referred to as a “selected rectangle”.

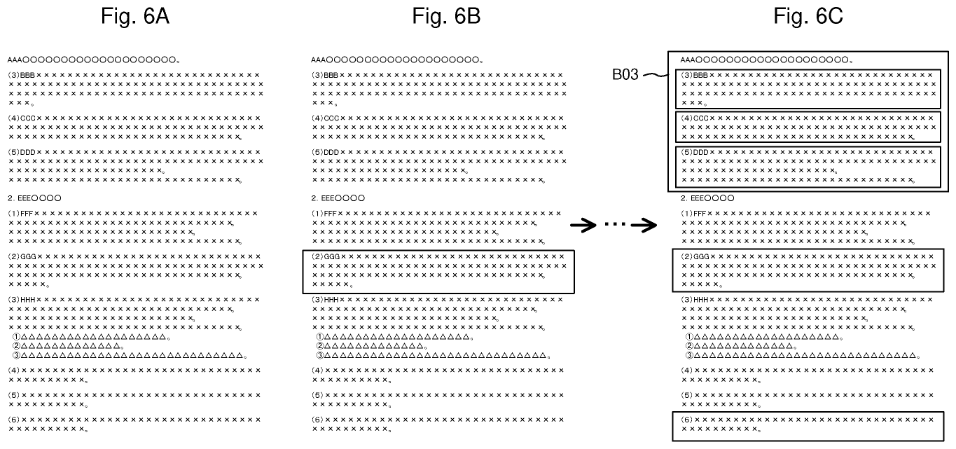

FIGS. 6A to 6C are diagrams for explaining the process performed by the rectangle selection unit 102. In FIGS. 6A to 6C, for convenience of description, document image data including only characters is used. As illustrated in FIG. 6A, first, the rectangle selection unit 102 initializes the selected rectangle to an empty set (that is, a set having no element). Next, as illustrated in FIG. 6B, the rectangle selection unit 102 selects a candidate rectangle having a highest prediction probability of the object detection model. Then, the rectangle selection unit 102 calculates an index representing suitability of a selection state. For example, a coverage ratio, an overlap ratio, a non-overlap ratio, a size of a selected rectangle, a combination thereof, or the like is used as the index representing the suitability of the selection state. In the present example embodiment, a combination of the coverage ratio (R1) and the overlap ratio (R2) is used as an index representing the suitability of the selection state. The index (I) representing the suitability of the selection state is represented by, for example, the following formula. W1 and W2 denote preset weights.

I=(R1×W1)+{(1/R2)×W2}

The coverage ratio is represented by, for example, a percentage of the area of the union of the selected rectangles to the area of the entire document image data. The overlap ratio is represented by, for example, a percentage of the area of a portion where two or more rectangular regions overlap with each other to the area of the entire document image data.

The index (I) is not limited to the above, and for example, an average of the coverage ratio and the non-overlap ratio, or the like may be defined as the index. The non-overlap ratio is represented by, for example, a percentage of the area of a region covered by one or less selected rectangles to the entire image.

In a case where the index representing the suitability of the selection state is not improved, the rectangle selection unit 102 does not add any selected rectangle. On the other hand, in a case where the index representing the suitability of the selection state is improved, the rectangle selection unit 102 adds a selected rectangle. Then, the rectangle selection unit 102 selects a candidate rectangle having the next highest prediction probability of the object detection model and repeats the above process.

FIG. 6C illustrates the middle of the selection process by the rectangle selection unit 102. In FIG. 6C, it is assumed that the candidate rectangle B03 is newly added by the rectangle selection unit 102. After the candidate rectangle 03 is added, the overlap ratio increases, whereas the coverage ratio does not vary. In this case, the rectangle selection unit 102 does not add the candidate rectangle B03 as the selected rectangle and deletes the candidate rectangle B03.

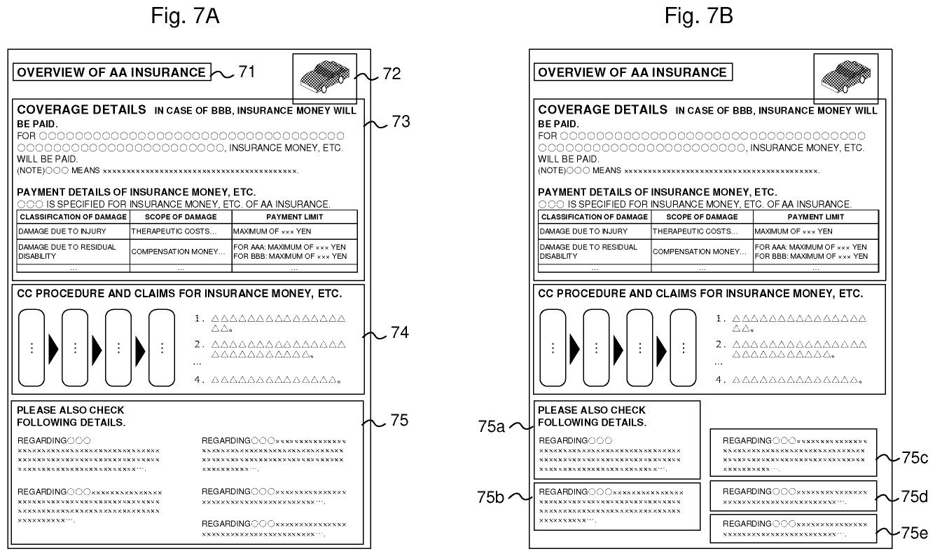

Returning to FIG. 3, the rectangle selection unit 102 outputs the selected rectangle set to the region segmentation unit 101. The region segmentation unit 101 performs region segmentation on each rectangular region included in the rectangle set. Then, the rectangle selection unit 102 selects a MECE rectangle set from the candidate rectangles. FIGS. 7A and 7B illustrate an example of region segmentation performed again by the region segmentation unit 101. FIG. 7A illustrates a rectangle set selected by the rectangle selection unit 102. The rectangle set includes rectangular regions 71 to 75. The region segmentation unit 101 performs region segmentation on each of the rectangular regions 71 to 75 in FIG. 7A. FIG. 7B illustrates a result of region segmentation performed by the region segmentation unit 101. In FIG. 7B, the rectangular region 75 is further segmented into rectangular regions 75a to 75e. It is determined that the rectangular regions 71 to 74 have been obtained by region segmentation sufficiently performed by the object detection model, and no further region segmentation has been performed.

In this manner, the region segmentation by the region segmentation unit 101 and the selection of the candidate rectangle by the rectangle selection unit 102 are recursively executed. By recursively executing the region segmentation, a rectangle set having information density optimal for a process by the VLM to be described later can be obtained.

In a case where a predetermined end condition is satisfied, the rectangle selection unit 102 outputs the rectangle set to the text conversion unit 103. A first example of the predetermined end condition is that the region segmentation has been sufficiently performed and the region segmentation by the object detection model is no longer performed. In this case, the rectangle selection unit 102 may only input each rectangular region included in the rectangle set repeatedly into the region segmentation unit 101 until the rectangular region can no longer be further segmented finely. A second example of the predetermined end condition is that, for all the rectangular regions included in the rectangle set, the percentage of the area (hereinafter, also referred to as an “area percentage”) of one rectangular region to the entire document image data becomes equal to or less than a predetermined value. In this case, the rectangle selection unit 102 calculates the area percentage of each rectangular region and inputs a rectangular region having the area percentage larger than the predetermined value into the region segmentation unit 101 again. Then, the rectangle selection unit 102 determines that the end condition has been satisfied in a case where the area percentages of all the rectangular regions become equal to or less than the predetermined value.

The text conversion unit 103 converts the document image data in each rectangular region of the rectangle set into text, using the VLM. Specifically, the text conversion unit 103 selects a prompt relevant to each rectangular region from among a plurality of prompts. The prompt is prepared in advance for each type of document element, and the text conversion unit 103 selects the prompt, based on the type of document element included in the rectangular region. For example, in a case where a table is included in the rectangular region, the text conversion unit 103 selects a prompt including an instruction to convert the table into text, from among the plurality of prompts. Then, the text conversion unit 103 inputs the rectangular region and the prompt relevant to that rectangular region into the VLM and acquires, from the VLM, text data obtained by converting the document image data in the rectangular region into text.

The following indicates examples of the prompts.
Example of a prompt in a case where the document element is text:
   “Convert the following document image into Markdown format text without excess or deficiency.”
Example of a prompt in a case where the document elements include a table:
   “Convert . . . below: if the table in the document contains a merged cell, split the cell and duplicate the contents into the split cells.”
Example of a prompt in a case where the document elements include a figure:
   “Convert . . . below: the graphs should be converted into a tabular form only if possible; diagrams should be converted into Mermaid format text; other figures should be described in natural language to include all the information in the figures.”

The text conversion unit 103 outputs the text data acquired from the VLM to the text database.

In the above configuration, the region segmentation unit 101 is an example of a partial region acquisition means, the rectangle selection unit 102 is an example of a selection means, and the text conversion unit 103 is an example of a conversion means.

The document image data is an example of content, and each region of the segmented document image data is an example of a partial region. The rectangle set is an example of a region set. The conversion into text by the text conversion unit 103 is an example of conversion into optional content by the conversion means.

### Processing Flow

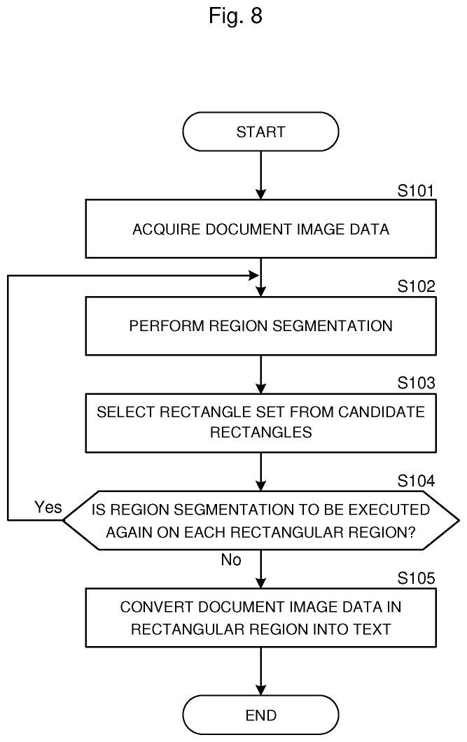

Next, the text conversion process performed by the information processing device 10 will be described. FIG. 8 is a flowchart of the text conversion process performed by the information processing device 10. This process is implemented by the processor 12 illustrated in FIG. 2 executing a program prepared in advance and operating as each element illustrated in FIG. 3.

First, the region segmentation unit 101 acquires document image data including a figure, a table, and the like through the I/F 11 (step S101). The region segmentation unit 101 performs region segmentation on the document image data focusing on a semantic group (step S102). The region segmentation unit 101 outputs the document image data subjected to region segmentation, to the rectangle selection unit 102.

Next, the rectangle selection unit 102 selects a MECE rectangle set from the candidate rectangles in the document image data (step S103). Next, the rectangle selection unit 102 verifies whether the region segmentation is to be executed again on each rectangular region. This verification is made using the predetermined end condition described above. In a case where the region segmentation is to be executed again (step S104: Yes), the rectangle selection unit 102 outputs the rectangle set to the region segmentation unit 101. Then, the process returns to step S102. On the other hand, in a case where the region segmentation is not to be executed again (step S104: No), the rectangle selection unit 102 outputs the rectangle set to the text conversion unit 103. Then, the process proceeds to step S105.

The text conversion unit 103 converts the document image data in each rectangular region into text (step S105). The text conversion unit 103 outputs the text data to the text database. The process then ends.

### Modified Example

Next, a modified example of the first example embodiment will be described.

The region segmentation unit 101 can perform region segmentation for the document image data, using one or more object detection models. In a case of using multiple object detection models, the region segmentation unit 101 combines the results of region segmentation by the multiple object detection models, that is, collects the candidate rectangles output by the multiple object detection models, and outputs the collected candidate rectangles to the rectangle selection unit 102. Then, the rectangle selection unit 102 selects a desired rectangle set from among the candidate rectangles. The object detection models may sometimes output different results of region segmentation depending on their types. By collecting the results of a plurality of different types of object detection models and selecting a rectangle set, fluctuations in accuracy can be prevented.

### Second Example Embodiment

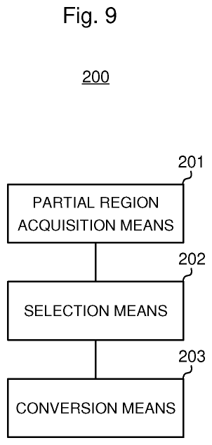

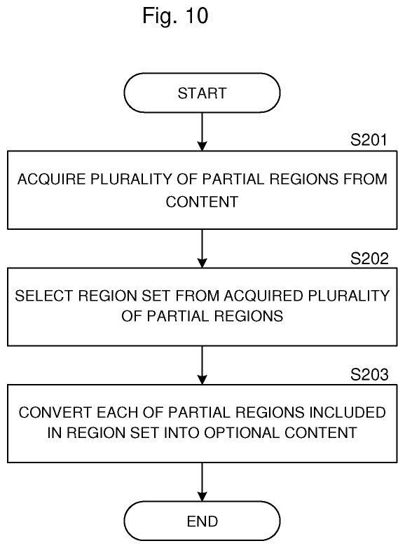

FIG. 9 is a block diagram illustrating a functional configuration of an information processing device according to a second example embodiment. An information processing device 200 includes a partial region acquisition means 201, a selection means 202, and a conversion means 203.

FIG. 9 is a flowchart of a process performed by the information processing device according to the second example embodiment. The partial region acquisition means 201 acquires a plurality of partial regions from content (step S201). The selection means 202 selects a region set from the plurality of partial regions (step S202). The conversion means 203 converts each of the partial regions included in the region set into optional content (step S203).

The partial region acquisition means 201 can be implemented using the region segmentation unit 101 according to the first example embodiment. The selection means 202 can be implemented using the rectangle selection unit 102 according to the first example embodiment. The conversion means 203 can be implemented using the text conversion unit 103 according to the first example embodiment.

According to the information processing device 200 of the second example embodiment, a document including a visual element can be converted into text.

Some or all of the example embodiments described above may also be described as, but are not limited to, the following Supplementary Notes.

### Supplementary Note 1

An information processing device including:
a partial region acquisition means for acquiring a plurality of partial regions from content;
a selection means for selecting a region set from the plurality of partial regions; and
a conversion means for converting each of the partial regions included in the region set into optional content.

### Supplementary Note 2

The information processing device according to Supplementary Note 1, in which the partial region acquisition means performs region segmentation for the content by using one or more object detection models, and
the one or more object detection models are models that output a plurality of partial regions forming a semantic group, from the content, in response to an input of the content.

### Supplementary Note 3

The information processing device according to Supplementary Note 1 or 2, in which the selection means selects one candidate at a time from the plurality of partial regions, and adds the one candidate to the region set in a case where a predetermined index is improved by adding the one candidate to the region set.

### Supplementary Note 4

The information processing device according to Supplementary Note 3, in which the predetermined index is an index representing suitability of a selection state, and includes a coverage ratio, an overlap ratio, sizes of the partial regions, or a combination thereof.

### Supplementary Note 5

The information processing device according to Supplementary Note 4, in which the predetermined index is a weighted sum of the coverage ratio and a reciprocal of the overlap ratio, or an average of the coverage ratio and the non-overlap ratio.

### Supplementary Note 6

The information processing device according to any one of Supplementary Notes 1 to 3, in which the partial region acquisition means performs region segmentation again on each partial region included in the region set, and
the selection means selects the region set from partial regions obtained by the region segmentation performed again.

### Supplementary Note 7

The information processing device according to any one of Supplementary Notes 1 to 3, in which the conversion means inputs each partial region included in the region set and a prompt relevant to the each partial region into a vision language model, and acquires text data of the each partial region separately from the vision language model.

### Supplementary Note 8

The information processing device according to Supplementary Note 7, in which the conversion means switches the prompt, based on an element included in the each partial region, and
the element includes at least one of a text, an image, or a table.

### Supplementary Note 9

An information processing method executed by a computer, the information processing method including:
acquiring a plurality of partial regions from content;
selecting a region set from the plurality of partial regions; and
converting each of the partial regions included in the region set into optional content.

### Supplementary Note 10

A program for causing a computer to execute a process including: acquiring a plurality of partial regions from content;
selecting a region set from the plurality of partial regions; and
converting each of the partial regions included in the region set into optional content.

Some or all of the configurations described in Supplementary Notes 2 to 8 dependent on the above-described Supplementary Note 1 can also be dependent on Supplementary Notes 9 and 10 by dependency relationships similar to those of Supplementary Notes 2 to 8. Some or all of the configurations described as the Supplementary Notes can be similarly dependent on not only Supplementary Notes 1, 9, and 10, but also diverse pieces of hardware and software, various recording means for recording software, or systems without departing from the above-described example embodiments.

While the present disclosure has been particularly shown and described with reference to example embodiments and examples thereof, the present disclosure is not limited to these example embodiments and examples. It will be understood by those of ordinary skill in the art that various changes in form and details may be made therein without departing from the spirit and scope of the present disclosure as defined by the claims.

### DESCRIPTION OF SYMBOLS

10 information processing device
101 region segmentation unit
102 rectangle selection unit
103 text conversion unit

1. An information processing device comprising:
at least one memory configured to store instructions; and
at least one processor configured to execute the instructions to:
acquire a plurality of partial regions from content;
select a region set from the plurality of partial regions; and
convert each of the partial regions included in the region set into optional content.

2. The information processing device according to claim 1, wherein the one or more processors perform region segmentation for the content by using one or more object detection models, and
the one or more object detection models are models that output a plurality of partial regions forming a semantic group, from the content, in response to an input of the content.

3. The information processing device according to claim 1, wherein the one or more processors select one candidate at a time from the plurality of partial regions, and adds the one candidate to the region set in a case where a predetermined index is improved by adding the one candidate to the region set.

4. The information processing device according to claim 3, wherein the predetermined index is an index representing suitability of a selection state, and includes a coverage ratio, an overlap ratio, sizes of the partial regions, or a combination thereof.

5. The information processing device according to claim 4, wherein the predetermined index is a weighted sum of the coverage ratio and a reciprocal of the overlap ratio, or an average of the coverage ratio and a non-overlap ratio.

6. The information processing device according to claim 1, wherein the one or more processors perform region segmentation again on each partial region included in the region set, and
the one or more processors select the region set from partial regions obtained by the region segmentation performed again.

7. The information processing device according to claim 1, wherein the one or more processors input each partial region included in the region set and a prompt relevant to the each partial region into a vision language model, and acquires text data of the each partial region separately from the vision language model.

8. The information processing device according to claim 7, wherein the one or more processors switch the prompt, based on an element included in the each partial region, and
the element includes at least one of a text, an image, or a table.

9. An information processing method executed by a computer, the information processing method comprising:
acquiring a plurality of partial regions from content;
selecting a region set from the plurality of partial regions; and
converting each of the partial regions included in the region set into optional content.

10. A non-transitory computer readable recording medium recording a program for causing a computer to execute processing comprising:
acquiring a plurality of partial regions from content;
selecting a region set from the plurality of partial regions; and
converting each of the partial regions included in the region set into optional content.
